(19) United States
(12) Patent Application Publication
(10) Pub. No.: US 2014/0185915 A1
(43) Pub. Date: Jul. 3, 2014

(54) DEVICE FOR DETERMINING SURFACE DEFECTS

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/092,935

(22) Filed: Nov. 28, 2013

(30) Foreign Application Priority Data
Dec. 27, 2012 (TW) 101150705

(51) Int. Cl. G06T 7/00

(52) U.S. Cl. CPC G06T 7/001
USPC 382/141

(57) ABSTRACT

A device for determining the existence or absence of surface defects includes a base, a movable platform, a support member, an image capturing unit, a light source unit, and a processing unit. The movable platform includes a main body for supporting the product, and a driving unit for moving the main body in six degrees of freedom, thereby orienting the product placed on the main body in different orientations. The support member carries an image capturing unit, which captures images of the product in the different orientations. The light source unit illuminates the product. The captured images of the product are analyzed and compared to reference images of a blemish-free standard product. If there is any discrepancy between the captured images and the reference images, the processing unit determines that the product has one or more surface defects.

### CROSS-REFERENCE TO RELATED APPLICATION

This application is related to one co-pending application entitled, “DEVICE FOR DETERMINING SURFACE DEFECTS,” filed **** (Atty. Docket No. U.S. Pat. No. 49,258).

### BACKGROUND

1. Technical Field

The present disclosure relates to devices and, more particularly, to a device for determining whether or not a product has surface defects.

2. Description of Related Art

In manufacturing, due to the need for high quality and efficient production, monitoring systems are required for checking products after they are manufactured. For example, there is a need to determine whether or not a product has any surface defects, such as scratching or smudging. In general, it is not economically feasible for such procedures to be carried out by means of manual labor. Furthermore, the possibility of technical inaccuracy and human error exists when human operators are used for monitoring.

Therefore, what is needed is a device to meet the above-described needs.

### BRIEF DESCRIPTION OF THE DRAWINGS

Many aspects of the present disclosure can be better understood with reference to the following drawings. The elements in the drawings are not necessarily drawn to scale, the emphasis instead being placed upon clearly illustrating the principles of the present disclosure. Moreover, in the drawings, like reference numerals designate corresponding parts throughout the views, and both the views are schematic.

FIG. 1 is an isometric view of a device for determining surface defects, in accordance with an exemplary embodiment.

FIG. 2 is a block diagram of the device of FIG. 1.

### DETAILED DESCRIPTION

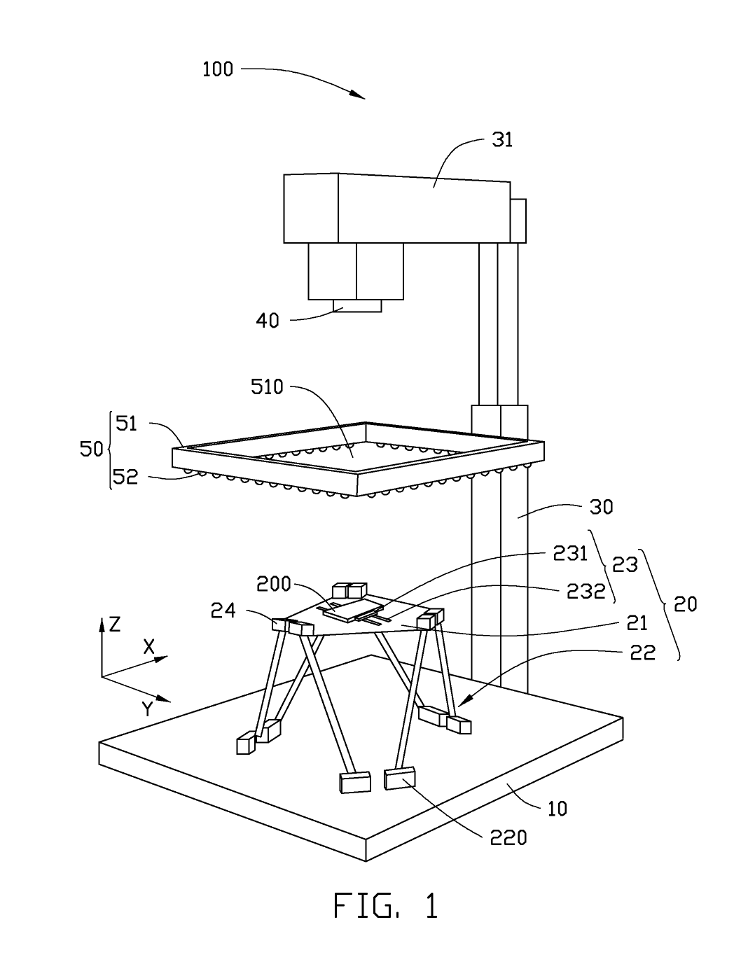

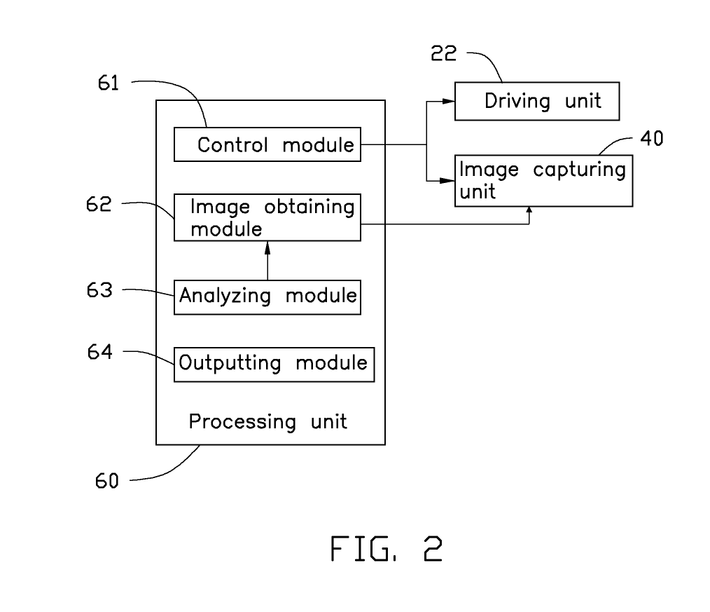

FIGS. 1-2 show an exemplary embodiment of a device 100 for determining whether or not a product 200 has any surface defects (e.g., scratching or other non-uniformity). The device 100 includes a base 10, a rotatable platform 20, a support member 30, an image capturing unit 40, a light source unit 50, and a processing unit 60.

The rotatable platform 20 includes a main body 21 and a driving unit 22. The main body 21 supports the product 200. The driving unit 22 includes six prismatic actuators 220 mounted in three pairs to the base 10. Each actuator 220 has a telescopic rod (not shown) extending obliquely upward therefrom. The two adjacent telescopic rods of each two adjacent pairs of actuators 220 converge toward each other and almost meet at a respective one of three mounting points 24 on corners of the main body 21. Thus, the main body 21, the driving unit 22 and the base 10 cooperatively form a Stewart platform, to move the main body 21 in six degrees of freedom, and thereby orient the product 200 placed on the main body 21 in different orientations. In the embodiment, the rotatable platform 20 further includes a fixing member 23, which is connected to a top surface of the main body 21. The product 200 is secured to the main body 21 through the fixing member 23.

In this embodiment, the fixing member 23 includes two fixing blocks 231, and two elastic elements 232 attached to the main body 21 and abutting against the fixing blocks 231. The distance between the two fixing blocks 231 is smaller than a width of the product 200. When the product 200 is placed between the two fixing blocks 231, the elastic elements 232 are elastically deformed, which causes the fixing blocks 231 to firmly grip the product 200, and thus secures the product 200 on the main body 21. The manner of connection and interaction between the main body 21 and the product 200 is not limited to the description herein, and can be varied according to need. For example, in an alternative embodiment, the fixing member 23 can be omitted, and the product 200 be directly placed on the main body 21.

The support member 30 is perpendicular to the base 10, with a bottom end portion of the support member 30 connected to the base 10. An arm 31 extends inward from a top end of the support member 30. The arm 31 is arranged above the main body 21 and is parallel to the main body 21.

The image capturing unit 40 is connected to the arm 31, and faces the main body 21 to capture images of the product 200 in the different orientations. In the embodiment, the image capturing unit 40 is a camera.

The light source unit 50 is arranged between the image capturing unit 40 and the main body 21. The light source unit 50 includes a frame 51 and a number of point light sources 52 (such as light emitting diodes). One side of the frame 51 is connected to the support member 30. The point light sources 52 are arranged along bottoms of all four sides of the frame 51. The frame 51 is parallel to the main body 21, and defines an opening 510. In this embodiment, the frame 51 is a hollow rectangular structure (FIG. 1) or an annular structure. Light reflected from the product 200 passes through the opening 510 and travels to the image capturing unit 40. The point light sources 52 emit light to provide sufficient lighting for the image capturing unit 40 to capture high quality images of the product 200. In this embodiment, a mechanical switch (not shown) is used to turn on or turn off the point light sources 52.

The processing unit 60 is arranged inside the base 10 or the support member 30. The processing unit 60 includes a control module 61, an image obtaining module 62, and an analyzing module 63, which comprise a collection of instructions executed by the processing unit 60.

The control module 61 communicates with the driving unit 22, and controls the driving unit 22 to drive the main body 21 to move in six degrees of freedom. The control module 61 further communicates with the image capturing unit 40 to capture the images of the product 200 in the different orientations. In the embodiment, the control module 61 controls the driving unit 22 to drive the main body 21 according to stored parameters. In an implementation, the stored parameters include the total number of times that the main body 21 is driven to move in the six degrees of freedom by the driving unit 22, and the time interval between each two times that the main body 21 is driven to move in the six degrees of freedom. In the present embodiment, the stored parameters are preset by a user via a peripheral input device (not shown), such as a keyboard.

The image obtaining module 62 obtains the captured images of the product 200.

The analyzing module 63 determines whether or not the product 200 has any surface defect according to the obtained images. In the embodiment, the analyzing module 63 compares the obtained images with a number of stored reference images showing different orientations of a blemish-free standard product. If each obtained image matches a corresponding one of the stored images of the standard product, the analyzing module 63 determines that the product 200 has no surface defect. If there is any discrepancy between the obtained images and the stored images, the analyzing module 63 determines that the product 200 has one or more surface defects. In an alternative embodiment, the analyzing module 63 may apply Fourier transformation to the obtained images to generate a number of frequency spectrograms, and determine whether or not the product 200 has a surface defect according to the frequency spectrograms. The technology of determining surface defects on a product according to frequency spectrograms is known in the art. See for example the subject matter of U.S. Pat. No. 7,069,154, which is incorporated herein by reference.

In the embodiment, the processing unit 60 further includes an outputting module 64. The outputting module 64 outputs the result of the determination by the analyzing module 63 to an electronic device (not shown). Specifically, the result output by the analyzing module 63 can be an audio file or a text message.

In an alternative embodiment, the processing unit 60 may be applied in a peripheral device (e.g., a computer), which communicates with the device 100 via a wireless access interface or a wired access interface.

Although the present disclosure has been specifically described on the basis of the exemplary embodiments thereof, the disclosure is not to be construed as being limited thereto. Various changes or modifications may be made to the embodiments without departing from the scope and spirit of the disclosure.

What is claimed is:

1. A device for determining whether or not a product has surface defects, the device comprising:
a base;
a movable platform comprising a main body and a driving unit, the main body configured for supporting the product, and the main body comprising three mounting points at three corners thereof, the driving unit comprising six actuators mounted in three pairs to the base, each actuator having a telescopic rod extending obliquely upward therefrom, two adjacent telescopic rods of each two adjacent pairs of actuators converging toward each other and almost meeting at a respective one of the mounting points of the main body, the main body, the driving unit and the base cooperatively forming a Stewart platform configured to move the main body in six degrees of freedom, thereby orienting the product positioned on the main body in different orientations;
a support member connected to the base, an arm extending inward from the support member;
an image capturing unit connected to the arm, and facing the main body to capture images of the product in the different orientations;
a light source unit arranged between the image capturing unit and the main body, and configured to illuminate the product; and
a processing unit comprising:
a control module configured to control the driving unit to drive the main body to move in the six degrees of freedom, and further control the image capturing unit to capture the images of the product in the different orientations;
an image obtaining module configured to obtain the captured images of the product; and
an analyzing module configured to determine whether or not the product has any surface defect according to the obtained images.

2. The device of claim 1, wherein the movable platform further comprises a fixing member, and the fixing member is connected to a top surface of the main body, and configured to secure the product to the main body.

3. The device of claim 2, wherein the fixing member comprises two fixing blocks and two elastic elements attached to the main body and abutting against the fixing blocks, and a distance between the two fixing blocks is smaller than a width of the product; and when the product is placed between the two fixing blocks, the elastic elements are elastically deformed, and the fixing blocks grip the product.

4. The device of claim 1, wherein the support member is perpendicular to the base, a bottom end portion of the support member is connected to the base, and the arm extends inward from a top end of the support member.

5. The device of claim 1, wherein the image capturing unit comprises a camera.

6. The device of claim 1, wherein the light source unit comprises a frame and a plurality of point light sources, one side of the frame is connected to the support member, and the point light sources are arranged along bottoms of all sides of the frame.

7. The device of claim 6, wherein the frame is parallel to the main body, and defines an opening for allowing light reflected from the product to pass therethrough and travel to the image capturing unit.

8. The device of claim 1, wherein the processing unit is arranged inside one of the base and the support member.

9. The device of claim 1, wherein the control module controls the driving unit to drive the main body according to a plurality of stored parameters, and the stored parameters comprise a total number of times that the main body is driven to move in the six degrees of freedom by the driving unit, and a time interval between each two times that the main body moves in the six degrees of freedom.

10. The device of claim 1, wherein the analyzing module compares the obtained images with a plurality of reference images showing different orientations of a standard product, and determines that the product has no surface defect if each obtained image matches a corresponding one of the reference images of the standard product.

11. The device of claim 1, wherein the analyzing module is configured to apply Fourier transformation to the obtained images to generate a plurality of frequency spectrograms, and to determine whether the product has any surface defect according to the frequency spectrograms.

12. The device of claim 1, wherein the processing unit further comprises an outputting module, and the outputting module is configured to output a result determined by the analyzing module to an electronic device.
